(19) United States
(12) Patent Application Publication
(10) Pub. No.: US 2025/0156657 A1
(43) Pub. Date: May 15, 2025

(54) METHOD AND APPARATUS FOR SPEECH TRANSLATION, ELECTRONIC DEVICE, AND MEDIUM

(71) Applicants: Lemon Inc., Grand Cayman (KY); Beijing Youzhuju Network Technology Co., Ltd., Beijing (CN)

(72) Inventors: Zhichao HUANG, Hong Kong (HK); Rong YE, Beijing (CN); Yu Ting KO, Hong Kong (HK); Qianqian DONG, Beijing (CN); Shanbo CHENG, Singapore (SG); Mingxuan WANG, Beijing (CN); Hang LI, Beijing (CN)

(21) Appl. No.: 18/942,104

(22) Filed: Nov. 8, 2024

(30) Foreign Application Priority Data
Nov. 10, 2023 (CN) 202311499033.0

(51) Int. Cl. G06F 40/58

(52) U.S. Cl. CPC G06F 40/58

(57) ABSTRACT

Embodiments of the present disclosure relate to a method and apparatus for speech translation, an electronic device, and a medium. The method includes obtaining an audio in a source language, where the audio includes a specific type of information. The method further includes obtaining prompt content related to a target language. In addition, the method further includes generating, based on the audio and the prompt content, a target-language text corresponding to the audio, where the target-language text includes a punctuation mark corresponding to the specific type of the information.

### CROSS-REFERENCE TO RELATED APPLICATION(S)

This application claims priority to Chinese Application No. 202311499033.0 filed on Nov. 10, 2023, the disclosure of which is incorporated herein by reference in its entirety.

### FIELD

Embodiments of the present disclosure relate to the field of computers, and in particular, to a method and apparatus for speech translation, an electronic device, and a medium.

### BACKGROUND

Speech translation is a speech-to-text processing process, and aims to translate speech in one language into text in another language, and has a wide range of application scenarios. Speech translation involves processing such as speech recognition, machine translation, and natural language processing, and is a complex cross-modal task.

Speech translation can help people communicate between different languages, eliminate language barriers, and promote cultural exchanges. The importance of speech translation is that it can help people understand and communicate better. With the development of technology, speech translation technology is also constantly evolving, becoming more accurate and intelligent, and bringing great convenience to people's lives.

### SUMMARY

Embodiments of the present disclosure provide a method and apparatus for speech translation, an electronic device, and a medium.

According to a first aspect of the present disclosure, a method for speech translation is provided. The method includes obtaining an audio in a source language, the audio including a specific type of information. The method further includes obtaining prompt content related to a target language. In addition, the method further includes generating, based on the audio and the prompt content, a target-language text corresponding to the audio, where the target-language text includes a punctuation mark corresponding to the specific type of the information.

According to a second aspect of the present disclosure, an apparatus for speech translation is provided. The apparatus includes a source audio obtaining module configured to obtain an audio in a source language, the audio including a specific type of information. The apparatus further includes a prompt content obtaining module configured to obtain prompt content related to a target language. In addition, the apparatus further includes a target text generation module configured to generate, based on the audio and the prompt content, a target-language text corresponding to the audio, where the target-language text includes a punctuation mark corresponding to the specific type of the information.

According to a third aspect of the present disclosure, an electronic device is provided. The electronic device includes a processor and a memory coupled to the processor, the memory having instructions stored therein, and the instructions, when executed by the processor, causing the electronic device to perform the method according to the first aspect.

In a fourth aspect of the present disclosure, a computer-readable storage medium is provided. The computer-readable storage medium has one or more computer instructions stored thereon, where the one or more computer instructions are executed by a processor to implement the method according to the first aspect.

The Summary section is intended to introduce a selection of concepts in a simplified form, which will be further described below in the Detailed Description of Embodiments. The Summary section is not intended to identify key features or essential features of the claimed subject matter, nor is it intended to limit the scope of the claimed subject matter.

### BRIEF DESCRIPTION OF THE DRAWINGS

The above and other features, advantages, and aspects of the embodiments of the present disclosure will become more apparent with reference to the following detailed description and in conjunction with the accompanying drawings. In the drawings, the same or similar reference numerals denote the same or similar elements, in which:

FIG. 1 shows a schematic diagram of an example environment in which embodiments of the present disclosure can be implemented;

FIG. 2 shows a flowchart of a method for speech translation according to an embodiment of the present disclosure;

FIGS. 3 to 6 are schematic diagrams of a process for generating a target-language text according to an embodiment of the present disclosure;

FIG. 7 is a schematic diagram of a process of fine-tuning a speech translation model according to an embodiment of the present disclosure;

FIG. 8 shows a block diagram of an apparatus for speech translation according to some embodiments of the present disclosure; and

FIG. 9 shows a block diagram of an electronic device according to some embodiments of the present disclosure.

Throughout the drawings, the same or similar reference numerals denote the same or similar elements.

### DETAILED DESCRIPTION OF EMBODIMENTS

It may be understood that before the technical solutions disclosed in the embodiments of the present disclosure are used, the user should be informed of the type, scope of use, usage scenarios, and the like of the personal information (such as speech) involved in the present disclosure in an appropriate manner in accordance with relevant laws and regulations, and the user's authorization should be obtained.

For example, when a user's active request is received, a prompt message is sent to the user, to explicitly prompt the user that the operation requested by the user will need to obtain and use the user's personal information. In this way, the user can provide personal information (such as speech) to the software or hardware, such as an electronic device, an application, a server, or a storage medium, that performs the operation of the technical solution of the present disclosure according to the prompt information. It may be understood that the above notification and process of obtaining the user's authorization are only schematic and do not limit the implementation of the present disclosure. Other methods that meet relevant laws and regulations may also be applied to the implementation of the present disclosure.

It may be understood that the data involved in the technical solution of the present disclosure (including but not limited to the data itself, the obtaining or use of the data) should comply with the requirements of corresponding laws, regulations, and related provisions.

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include/comprise” and similar terms should be understood as open inclusion, that is, “include/comprise but not limited to”. The term “based on” should be understood as “at least partially based on”. The term “an embodiment” or “the embodiment” should be understood as “at least one embodiment”. The terms “first”, “second” and the like may refer to different or the same objects, unless expressly stated otherwise. Other explicit and implicit definitions may be included below.

The speech translation task aims to convert a source-language audio into a target-language text, for example, convert an English audio into a corresponding Chinese text. When people speak, punctuation marks are not reflected in the speech or audio. However, in the existing speech translation applications, when performing speech translation, corresponding punctuation marks cannot be added to the translation text based on specific words in the audio, resulting in that the user finds the translation text stiff and poor in fluency and readability when using the translation text, resulting in a poor user experience.

To solve the above problem, the embodiments of the present disclosure provide a speech translation solution. The solution can obtain an audio in a source language including a predetermined type of word, and then generate, in combination with prompt content, a target-language text corresponding to the audio, where the target-language text includes the word presented in a predetermined punctuation mark. In this way, by means of the solution provided in the embodiments of the present disclosure, when the audio in the source language includes the predetermined type of word, the corresponding punctuation mark can be presented in the translation text, thereby improving the accuracy, readability, and fluency of the speech translation result, avoiding translation problems caused by the absence of punctuation marks, and further improving a user experience in speech translation.

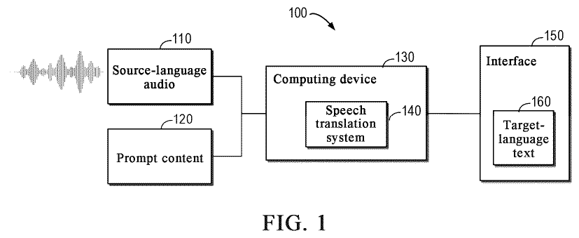

FIG. 1 shows a schematic diagram of an example environment 100 in which the method according to the embodiment of the present disclosure can be implemented. As shown in FIG. 1, the example environment 100 may include a source-language audio 110. The source-language audio 110 may be understood as a speech of a specific duration, for example, a user's speaking sound, which contains meaningful content and can usually be recorded in words. It may be understood that more or fewer audios may also be included in the environment 100. When people speak, the recorded audio does not include punctuation marks. However, when the audio is translated into a text in a target language, appropriate punctuation marks need to be added to the translation text, which can improve the readability and fluency of the translation text. In some cases, failure to add appropriate punctuation marks may lead to ambiguity or deviation in the translation text. For example, if the source-language audio 110 includes a word related to a title of a work such as a book title, an article title, a newspaper title, a file name, or the like, the translation text may include a book title mark to present the title of the work.

The example environment 100 further includes prompt content 120. For example, if the source-language audio needs to be translated into a Chinese text, the prompt content 120 may be “Please translate the source-language audio into a Chinese text”, or may be prompt content in English: “Translate the speech into English text”. A speech translation system 140 may generate a corresponding Chinese text based on the source-language audio and the prompt content. The speech translation system 140 includes a speech representation model. In some embodiments, the speech representation model may be a speech model pre-trained using a weak supervision method, and may generate a speech representation of the source-language audio 110. In addition, the speech representation model may be a speech model trained using an unsupervised method, which is not limited in the present disclosure.

In some embodiments, the speech representation model may be a speech representation model of an encoder-decoder transformation architecture trained through weak supervision learning. Many speech models rely on high-quality labeled audio/text data for supervision learning. A model trained in this manner can generate good speech recognition results under ideal conditions, but due to the limited amount of labeled data, it is often not well generalized, may encounter difficulties in processing low-quality real-world audio, and usually requires additional speech fine-tuning to prepare for a specific use case. In addition, a large amount of unlabeled audio is used to develop an unsupervised learning speech representation model. A model created in this manner can implement very high-quality speech representations, but requires subsequent fine-tuning to prepare for a specific speech task. In addition, in some embodiments, the speech representation model may be an unsupervised model implemented using clustering to generate the speech representation 306 of the source-language audio 110, and the speech representation model may be fine-tuned and trained with the speech translation system 140 to achieve a better speech representation effect.

The speech representation of the source-language audio 110 can be generated using the speech representation model, and the speech translation system 140 may process the speech representation. When processing the speech representation, the corresponding prompt content 120 needs to be obtained. In some embodiments, the prompt content 120 may be “Please convert the source-language audio into a target-language text”, and the speech translation system 140 may generate a corresponding target-language text based on the prompt content and the speech representation. A translation text corresponding to the source-language audio 110 may be generated by inputting the speech representation and the prompt content 120 into a speech translation model 140.

The prompt content 120 may be in various language types, and the embodiments of the present disclosure do not limit the language type of the prompt content. In addition, the source-language audio 110 may be translated into a text in any language. For example, the prompt content 120 may further be “Please translate the source-language audio into an English text”, and then the source-language audio 110 will be translated into a corresponding English text. The prompt content 120 may further be “Please translate the source-language audio into a German text”, and then the source-language audio 110 will be translated into a corresponding German text. In some embodiments, the source-language audio 110 may be an audio in a non-written language, for example, an audio in a minority language without words, and can still be translated into a text in a corresponding language.

With continued reference to FIG. 1, the example environment 100 includes a computing device 130, which may be a user terminal, a mobile device, a computer, or the like, and may also be a computing system, a single server, a distributed server, or a cloud-based server. The computing device 130 may receive the source-language audio 110. The computing device 130 may further include a speech translation system 140. For example, the speech translation system 140 is deployed in the computing device 130. The speech translation system 140 may be used to generate a translation result of the source-language audio 110, that is, a target-language text 160, based on the source-language audio 110, for display in an interface 150. In some embodiments, the speech translation system 140 may be obtained by pre-training using a large-scale chapter-level multilingual document and fine-tuning using a plurality of tasks such as a speech recognition task, a machine translation task, and a speech translation task, based on the architecture of a generative pre-trained model.

It should be understood that the architecture and functions in the example environment 100 are described only for exemplary purposes, and do not imply any limitation on the scope of the present disclosure. The embodiments of the present disclosure may also be applied to other environments with different structures and/or functions.

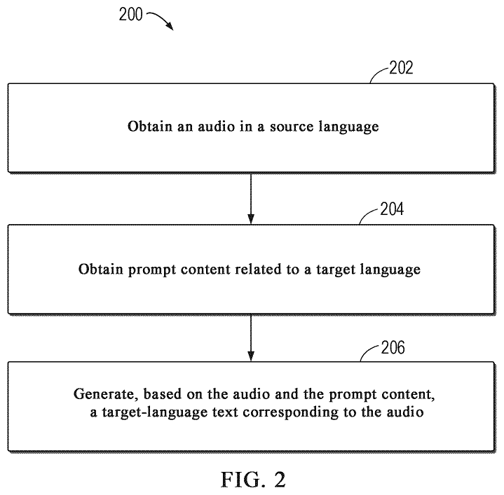

The process according to the embodiments of the present disclosure will be described in detail below with reference to FIGS. 2 to 9. For ease of understanding, specific data mentioned in the following description are all exemplary and are not intended to limit the scope of protection of the present disclosure. It may be understood that the embodiments described below may further include additional actions that are not shown and/or may omit the shown actions. The scope of the present disclosure is not limited in this respect.

FIG. 2 shows a flowchart of a method 200 for speech translation according to an embodiment of the present disclosure. At block 202, an audio in a source language is obtained, the audio including a specific type of information. For example, with reference to FIG. 1, the speech translation system 140 may obtain the source-language audio 110, and the source-language audio 110 may include a word related to a title of a work such as a book title, an article title, a newspaper title, a file name, or the like.

At block 204, prompt content related to a target language is obtained. For example, with reference to FIG. 1, the speech translation system 140 may obtain the prompt content 120, and the prompt content may be “Please convert the source-language audio into a Chinese text” or “convert into an English text” or the like, to indicate the speech translation system to perform a speech translation task to translate the source-language audio into a target-language text.

At block 206, a target-language text corresponding to the audio is generated based on the audio and the prompt content, where the target-language text includes a punctuation mark corresponding to the specific type of the information. For example, with reference to FIG. 1, the speech translation system 140 may generate the target-language text 160 based on the source-language audio 110 and the prompt content 120, where the target-language text includes a word presented in a predetermined punctuation mark. For example, when a word of a title of a work type is included in the source-language audio, the title of the work is presented in the target-language text in the form of a book title mark. It should be understood that the word of the title of the work type and the book title mark mentioned here are only examples, and the embodiments of the present disclosure do not limit the types of words and punctuation marks.

In this way, by means of the method 200 provided in the embodiments of the present disclosure, when the audio in the source language includes the specific type of the information, the corresponding punctuation mark can be presented in the translation text, thereby improving the accuracy, readability, and fluency of the speech translation result, avoiding translation problems caused by the absence of punctuation marks, and further improving a user experience in speech translation.

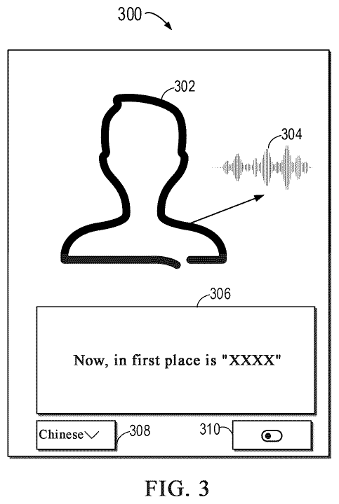

FIG. 3 is a schematic diagram of a process 300 for generating a target-language text according to an embodiment of the present disclosure. For ease of understanding, FIG. 3 describes the process 300 of generating the target-language text by using a video caption translation scenario as an example. It should be understood that the embodiments of the present disclosure do not limit the application scenarios of speech translation, and may be applied to various scenarios such as speeches, teaching, travel, or meetings.

In FIG. 3, a video character 302 is speaking, and a corresponding audio is 304. A speech translation application (for example, the speech translation application 140 in FIG. 1) may obtain the audio 304. In addition, since it is a caption translation scenario, the prompt content may be “Please translate the source-language audio into a target language”. A user may also select a type of the target language by using a button 308. For example, the target language may be Chinese, English, German, or the like. In addition, the user may also select to turn on or off the speech translation application by using a switch 310. The speech translation application may generate a translation text 306 and display the translation text in a display box.

In some embodiments, the source-language audio 304 may include a word related to a title of a work such as a book title, an article title, a newspaper title, a file name, or the like. For example, the audio 304 may be “Now, down to number one, we have XXXX.”, where “XXXX” is a book title. It should be understood that the audio text listed here is used to show the audio content, and includes punctuation marks such as commas and periods. In fact, the audio 304 itself does not reflect any punctuation marks. In response to determining that the audio 304 includes the word of the title of the work type, the generated translation text 306 may be “Now, in first place is “XXXX””, and the translation text 306 includes the book title presented in a book title mark. Since the book title mark is added to the translation text 306, the user can intuitively understand that this sentence is related to the book, thereby improving the readability and accuracy of the translation text. In contrast, if the translation text 306 is “Now, in first place is “XXXX””, the user cannot intuitively understand what “XXXX” is when browsing and reading, resulting in an understanding obstacle or even a deviation.

In addition, the audio 304 may be “And so while we had signs up that said “No swimming,” there weren't any signs up that said “No swimming. Alligators.””. It should be understood that the audio text listed here is used to show the audio content, and includes punctuation marks such as commas, periods, and quotation marks. In fact, the audio 304 itself does not reflect any punctuation marks. A corresponding translation text 306 may be: “So, while we have signs that say “no swimming”, we don't have signs that say “no swimming crocodiles””. Since the translation text 306 includes the content presented in double quotation marks, the user can intuitively understand the content on the sign, thereby improving the readability of the translation text 306. In contrast, if the translation text is “So, while we have signs that say no swimming, we don't have signs that say no swimming crocodiles”, the user cannot intuitively understand the sign information, resulting in poor readability of the translation text 306.

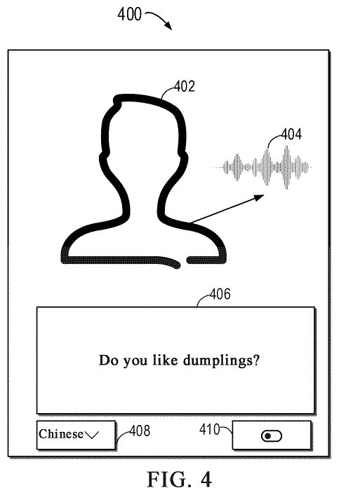

FIG. 4 is a schematic diagram of a process 400 for generating a target-language text according to an embodiment of the present disclosure. Similar to FIG. 3, for ease of understanding, FIG. 4 describes the process 400 of generating the target-language text by using a video caption translation scenario as an example. In FIG. 4, a video character 402 is speaking, and a corresponding audio is 404. A speech translation application (for example, the speech translation application 140 in FIG. 1) may obtain the audio 404. In addition, as described above, since it is a caption translation scenario, the prompt content may be “Please translate the source-language audio into a target language”. Similarly, a user may also select a type of the target language by using a button 408. For example, the target language may be Chinese, English, German, or the like. In addition, the user may also select to turn on or off the speech translation application by using a switch 410. The speech translation application may generate a translation text 406 and display the translation text in a display box.

In some embodiments, the audio 404 may include some specific modal information, reflecting the speaker's attitude towards an action, including but not limited to an interrogative modal, an imperative modal, an exclamatory modal, and the like. For example, the audio 404 may be “You guys like dumplings?”, and it should be understood that the audio text listed here is used to show the audio content. In fact, the audio 404 itself does not include a question mark. In response to determining that the audio 404 includes the interrogative modal, the generated translation text 406 may be “Do you like dumplings?”, and the translation text 406 includes a modal particle “Do” and a question mark “?”. In this way, the user can understand that the speaker expresses an interrogative modal, thereby improving the accuracy of the translation text. In contrast, if the interrogative modal is not reflected in the translation text 306, but is “You like dumplings.”, when seeing the translation text 306, the user cannot know that it is an interrogative modal, and may wrongly understand it as a declarative modal, resulting in a deviation.

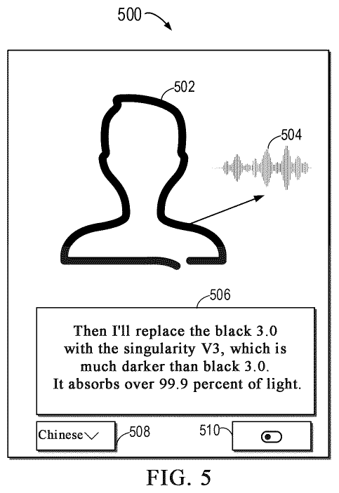

FIG. 5 is a schematic diagram of a process 500 for generating a target-language text according to an embodiment of the present disclosure. Similar to FIG. 3, for ease of understanding, FIG. 5 describes the process 500 of generating the target-language text by using a video caption translation scenario as an example. In FIG. 5, a video character 502 is speaking, and a corresponding audio is 504. A speech translation application (for example, the speech translation application 140 in FIG. 1) may obtain the audio 504. In addition, as described above, since it is a caption translation scenario, the prompt content may be “Please translate the source-language audio into a target language”. Similarly, a user may also select a type of the target language by using a button 508. For example, the target language may be Chinese, English, German, or the like. In addition, the user may also select to turn on or off the speech translation application by using a switch 510. The speech translation application may generate a translation text 506 and display the translation text in a display box.

In some embodiments, the audio 504 may include some number content, including but not limited to objects such as numbers, amounts of money, dates, and addresses. However, when converting into a translation text, the number content needs to be presented in a standardized format to conform to reading habits and improve readability. For example, the audio 504 may include “twenty percent”, which needs to be standardized and presented as “20%”; the audio 504 may include “one thousand six hundred eighty RMB”, which needs to be standardized and presented as “1680 RMB”; the audio 504 may include “May, 11”, which needs to be standardized and presented as “May, 11”, and the like. In addition, in some embodiments, the audio 504 may be “and then I'll replace the black 3.0 with the singularity v3. Much darker than black 3.0, this absorbs over 99.9 percent of light.”, and a generated translation text may be “and then I'll replace the black 3.0 with the singularity v3. Much darker than black 3.0, this absorbs over 99.9% of light”. Here, “99.9 percent” is standardized and presented as “99.9%”, improving the readability of the translation text 604.

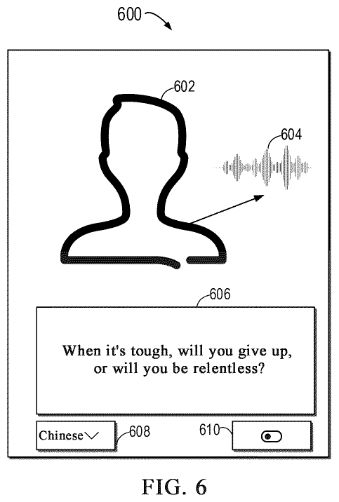

FIG. 6 is a schematic diagram of a process 600 for generating a target-language text according to an embodiment of the present disclosure. Similar to FIG. 3, for ease of understanding, FIG. 6 describes the process 600 of generating the target-language text by using a video caption translation scenario as an example. In FIG. 6, a video character 602 is speaking, and a corresponding audio is 604. A speech translation application (for example, the speech translation application 140 in FIG. 1) may obtain the audio 604. In addition, as described above, since it is a caption translation scenario, the prompt content may be “Please translate the source-language audio into a target language”. Similarly, a user may also select a type of the target language by using a button 608. For example, the target language may be Chinese, English, German, or the like. In addition, the user may also select to turn on or off the speech translation application by using a switch 610. The speech translation application may generate a translation text 606 and display the translation text in a display box.

In some embodiments, the audio 604 may include a polysemous word, but when converting into a translation text, a proper interpretation of the polysemous word needs to be determined based on the context of the audio. For example, the audio 604 may be “When it's tough, will you give up, or will you be relentless?”, and the generated translation text 606 may be “When it's tough, will you give up, or will you be relentless?”, where “relentless” is a polysemous word, and may be interpreted as “no mercy”, “cruel”, “perseverant”, or the like. The translation text 606 translates it as “perseverant” based on the context, which is more consistent with “give up” in the preceding text. In contrast, if “relentless” is translated into other interpretations, for example, the translation text 606 is “When it's tough, will you give up, or will you show no mercy?”, which may lead to a deviation in understanding and reduce the quality of the speech translation.

In addition, in some embodiments, the audio 604 may include some proper nouns, for example, place names, personal names, or organization names, and the proper nouns need to be retained in the translation text. For example, the audio 604 may be “I learned about Sanbeiji, basil is always part of the dish.”, and a corresponding translation text 606 may be “I learned about Sanbeiji, basil is always part of the dish.”, where the audio 604 includes a proper noun “Sanbeiji”, and the translation text 606 retains it and translates it into a corresponding Chinese form. In addition, the audio 604 may be “The next time you go to an authentic Szechuan restaurant, order any of the following dishes I'm gonna be talking about.”, and a corresponding translation text 606 may be “The next time you go to an authentic Szechuan restaurant, order any of the following dishes I'm gonna be talking about.”, where “Szechuan restaurant” is a proper noun, and the translation text 606 retains it and translates it into “Szechuan restaurant”.

In addition, in some embodiments, the audio 604 may include some multilingual content, for example, a case where Chinese and English are mixed. For example, the audio 604 may be “Fu Qi Fei Pian literally means slices of husband and wife's lungs.”, and the translation text 606 may be “Fu Qi Fei Pian literally means slices of husband and wife's lungs.”, where “Fu Qi Fei Pian” is in Chinese, and the translation text 606 retains it and converts it into a Chinese text.

In addition, in some embodiments, the audio 606 may include repeated adverbs, which is common in spoken language, but when converting into a translation text, it will result in poor readability. For example, the audio 606 may be “There are people out there who have a very very low level of English and they can communicate very very well.”, and the translation text 606 may be “There are people out there who have a very low level of English and they can communicate very well.”, where “very very” in the audio 604 is a repeated adverb, and the translation text 606 de-duplicates the repeated adverb.

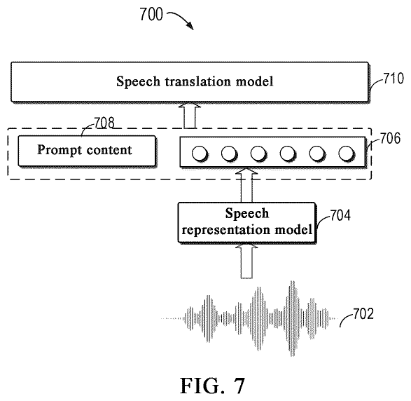

FIG. 7 is a schematic diagram of a process 700 of fine-tuning a speech translation model according to an embodiment of the present disclosure. In the embodiments of the present disclosure, the speech translation model may be in the speech translation system 140 shown in FIG. 1, and may be obtained by pre-training using a large-scale chapter-level multilingual document and fine-tuning using a plurality of tasks such as a speech recognition task, a machine translation task, and a speech translation task, based on the architecture of a generative pre-trained model. First, a source-language audio 702 is obtained. For example, the audio 702 may be an English audio. It should be understood that the English audio is used as the source-language audio as an example, and the present disclosure does not limit the language type of the source-language audio. Then, a speech representation 706 of the source-language audio 704 is generated by using a speech representation model 704. In some embodiments, the speech representation model 704 may be a speech representation model of an encoder-decoder transformation architecture trained through weak supervision learning. In some embodiments, the source-language audio 702 may be in English and needs to be translated into a Chinese text, and then the prompt content 708 may be “Transcribe the audio and then translate it into Chinese: {transcribed text}, {translation text}” to fine-tune the speech translation model.

In some embodiments, for the case that the source-language audio 702 includes a predetermined type of word and a predetermined type of punctuation mark needs to be added to the translation text, the speech translation model may be pre-trained using a large-scale chapter-level document, and these training corpus include the predetermined type of word and the punctuation mark. In addition, the speech translation model is fine-tuned using a punctuated task to improve the processing capability of the speech translation model. For example, the prompt content 708 may be “Add punctuation to {text}: {punctuated text}”, for example, the prompt content is: Add punctuation to {I think when some people see a No Swimming sign, they'll send a kid down to the water with a shovel and a bucket.}: {I think when some people see a “No Swimming” sign, they'll send a kid down to the water with a shovel and a bucket.}. In this way, the speech translation task is fine-tuned using the punctuated task, which can improve the capability of the speech translation model to correctly add punctuation marks when generating the translation text, thereby improving the fluency and readability of the translation text and improving the user experience when seeing the translation text.

In some embodiments, for the case that the source-language audio 702 includes modal information and a corresponding punctuation mark and a modal particle need to be added to the translation text, the speech translation model may be pre-trained using a large-scale chapter-level document to improve the language understanding capability and language reasoning capability of the speech translation model. In addition, the speech translation model may be fine-tuned using a task related to the modal information. For example, the prompt content 708 may be “Translate based on the modal information of the audio: {translation text correctly understanding the modal}”, to fine-tune the speech translation model, so that the model understands the correct modal and translates it correctly.

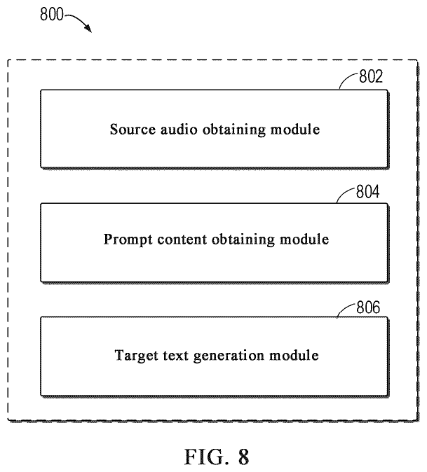

FIG. 8 shows a block diagram of an apparatus 800 for speech translation according to some embodiments of the present disclosure. As shown in FIG. 8, the apparatus 800 includes a source audio obtaining module 802 configured to obtain an audio in a source language, the audio including a specific type of information. The apparatus 800 further includes a prompt content obtaining module 804 configured to obtain prompt content related to a target language. In addition, the apparatus 800 further includes a target text generation module 806 configured to generate, based on the audio and the prompt content, a target-language text corresponding to the audio, where the target-language text includes a punctuation mark corresponding to the specific type of the information.

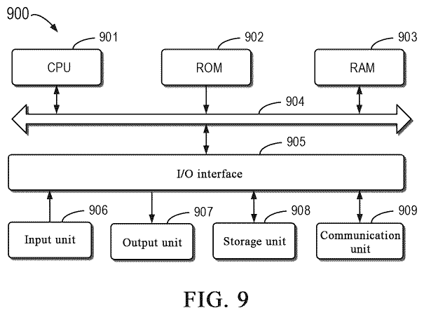

FIG. 9 shows a block diagram of an electronic device 900 according to some embodiments of the present disclosure. FIG. 9 shows a block diagram of an electronic device 900 according to some embodiments of the present disclosure, and the device 900 may be the device or apparatus described in the embodiments of the present disclosure. As shown in FIG. 9, the device 900 includes a central processing unit (CPU) and/or a graphics processing unit (GPU) 901, which may perform various appropriate actions and processing in accordance with a computer program instruction stored in a read-only memory (ROM) 902 or a computer program instruction loaded from a storage unit 908 into a random access memory (RAM) 903. The RAM 903 may further store various programs and data required for the operation of the device 900. The CPU/GPU 901, the ROM 902, and the RAM 903 are connected to each other through a bus 904. An input/output (I/O) interface 905 is also connected to the bus 904. Although not shown in FIG. 9, the device 900 may further include a coprocessor.

A plurality of components in the device 900 are connected to the I/O interface 905, including: an input unit 906, such as a keyboard and a mouse; an output unit 907, such as various types of displays and speakers; the storage unit 908, such as a magnetic disk and an optical disk; and a communication unit 909, such as a network card, a modem, a wireless communication transceiver, and the like. The communication unit 909 allows the device 900 to exchange information/data with other devices via a computer network such as the Internet and/or various telecommunication networks.

Each of the foregoing methods or processes may be performed by the CPU/GPU 901. For example, in some embodiments, the method may be implemented as a computer software program tangibly included in a machine-readable medium, for example, the storage unit 908. In some embodiments, part or all of the computer program may be loaded and/or installed onto the device 900 via the ROM 902 and/or the communication unit 909. When the computer program is loaded into the RAM 903 and executed by the CPU/GPU 901, one or more steps or actions in the above-described methods or processes may be performed.

In some embodiments, the above-described methods and processes may be implemented as a computer program product. The computer program product may include a computer-readable storage medium having computer-readable program instructions thereon for performing various aspects of the present disclosure.

The computer-readable storage medium may be a tangible device that can retain and store instructions used by an instruction execution device. The computer-readable storage medium may be, for example but not limited to, an electrical storage device, a magnetic storage device, an optical storage device, an electromagnetic storage device, a semiconductor storage device, or any suitable combination thereof. A more specific example (non-exhaustive list) of the computer-readable storage medium includes: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, for example, a punched card or a raised structure in a groove on which instructions are stored, and any suitable combination thereof. The computer-readable storage medium described herein is not interpreted as a transient signal per se, such as radio waves or other freely propagated electromagnetic waves, electromagnetic waves propagated through a waveguide or other transmission medium (for example, light pulses passing through a fiber-optic cable), or electrical signals transmitted through wires.

The computer-readable program instructions described herein may be downloaded from a computer-readable storage medium to various computing/processing devices, or downloaded to an external computer or external storage device over a network, for example, the Internet, a local area network, a wide area network, and/or a wireless network. The network may include copper transmission cables, optical fiber transmission, wireless transmission, routers, firewalls, switches, gateway computers, and/or edge servers. A network adapter or network interface in each computing/processing device receives the computer-readable program instructions from the network, and forwards the computer-readable program instructions for storage in a computer-readable storage medium in the various computing/processing devices.

The computer program instructions for performing the operations of the present disclosure may be assembly instructions, instruction set architecture (ISA) instructions, machine instructions, machine-related instructions, microcode, firmware instructions, state setting data, or source code or target code written in one or more programming languages, where the programming languages include an object-oriented programming language and conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to the computer of the user over any type of network, including a local area network (LAN) or a wide area network (WAN), or may be connected to an external computer (for example, connected over the Internet using an Internet service provider). In some embodiments, an electronic circuit, for example, a programmable logic circuit, a field programmable gate array (FPGA), or a programmable logic array (PLA), is personalized by using state information of the computer-readable program instructions, and the electronic circuit may execute the computer-readable program instructions, to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or another programmable data processing apparatus, generate a device for implementing the functions/actions specified in one or more blocks in the flowcharts and/or block diagrams. These computer-readable program instructions may also be stored in a computer-readable storage medium. These instructions enable a computer, a programmable data processing apparatus, and/or another device to work in a specific manner. Therefore, the computer-readable medium storing the instructions includes a product manufactured, which includes instructions for implementing various aspects of the functions/actions specified in one or more blocks in the flowcharts and/or block diagrams.

The computer-readable program instructions may also be loaded onto a computer, another programmable data processing apparatus, or another device, such that a series of operation steps are performed on the computer, another programmable data processing apparatus, or another device to produce a computer-implemented process, such that the instructions executed on the computer, another programmable data processing apparatus, or another device implement the functions/actions specified in one or more blocks in the flowcharts and/or block diagrams. The flowcharts and block diagrams in the accompanying drawings show possible system architectures, functions, and operations of the device, the method, and the computer program product according to a plurality of embodiments of the present disclosure. In this regard, each block in the flowchart or block diagram may represent a module, program segment, or part of an instruction, and the module, program segment, or part of the instruction contains one or more executable instructions for implementing the specified logical functions. In some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or actions, or may be implemented by a combination of dedicated hardware and computer instructions.

The foregoing describes various embodiments of the present disclosure. The foregoing descriptions are exemplary, not exhaustive, and are not limited to the disclosed embodiments. Many modifications and changes are obvious to those of ordinary skill in the art without departing from the scope and spirit of the described embodiments. The selection of terms used herein is intended to best explain the principles, practical applications, or technical improvements to the technologies in the market of the embodiments, or to enable other ordinary skilled persons in the art to understand the embodiments disclosed herein.

Some example implementations of the present disclosure are listed below.

Example 1. A method for speech translation, including:
obtaining an audio in a source language, the audio including a specific type of information;
obtaining prompt content related to a target language; and
generating, based on the audio and the prompt content, a target-language text corresponding to the audio, where the target-language text includes a punctuation mark corresponding to the specific type of the information.

Example 2. The method according to Example 1, where the specific type of the information is a predetermined type of word, and generating the target-language text corresponding to the audio includes:
generating the target-language text including a word presented in a predetermined punctuation mark.

Example 3. The method according to Example 1 or 2, further including:
in response to determining that a second audio includes modal information, generating a target-language text corresponding to the second audio, where the target-language text includes a punctuation mark and a modal particle corresponding to the modal information.

Example 4. The method according to any one of Examples 1 to 3, further including:
in response to determining that a third audio includes a number, generating a target-language text corresponding to the third audio, where the target-language text includes number content presented in a standardized format.

Example 5. The method according to any one of Examples 1 to 4, further including:
in response to determining that a fourth audio includes a polysemous word, generating a target-language text corresponding to the fourth audio, where the target-language text includes a target word of the polysemous word that is related to the context of the audio.

Example 6. The method according to any one of Examples 1 to 5, further including:
in response to determining that a fifth audio includes a proper noun, generating a target-language text corresponding to the fifth audio, where the target-language text retains the proper noun.

Example 7. The method according to any one of Examples 1 to 6, further including:
in response to determining that a sixth audio includes multilingual content, generating a target-language text corresponding to the sixth audio, where the target-language text retains content in a target language in the multilingual content.

Example 8. The method according to any one of Examples 1 to 7, further including:
in response to determining that a seventh audio includes a repeated adverb, generating a target-language text corresponding to the seventh audio, where an adverb in the target-language text is de-duplicated.

Example 9. The method according to any one of Examples 1 to 8, where the target-language text is generated by a speech translation model, and the speech translation model is pre-trained with a chapter-level multilingual document and adjusted using a plurality of tasks.

Example 10. The method according to any one of Examples 1 to 9, where adjusting the speech translation model using the plurality of tasks includes:
obtaining a source-language audio and a corresponding punctuated source-language text;
obtaining corresponding prompt content based on a punctuated speech transcription task; and
adjusting the speech translation model based on the corresponding prompt content, the source-language audio, and the corresponding punctuated source-language text.

Example 11. The method according to any one of Examples 1 to 10, where adjusting the speech translation model using the plurality of tasks includes:
obtaining a source-language audio and a corresponding target-language text with a modal particle;
obtaining corresponding prompt content based on a speech translation task; and
adjusting the speech translation model based on the corresponding prompt content, the source-language audio, and the corresponding target-language text with the modal particle.

Example 12. An apparatus for speech translation, including:
a source audio obtaining module configured to obtain an audio in a source language, the audio including a specific type of information;
a prompt content obtaining module configured to obtain prompt content related to a target language; and
a target text generation module configured to generate, based on the audio and the prompt content, a target-language text corresponding to the audio, where the target-language text includes a punctuation mark corresponding to the specific type of the information.

Example 13. The apparatus according to Example 12, where the specific type of the information is a predetermined type of word, and the target text generation module is configured to:
a punctuated target text generation module configured to generate the target text including the word presented in a predetermined punctuation mark.

Example 14. The apparatus according to Example 12 or 13, where the apparatus further includes:
a second target text generation module configured to, in response to determining that a second audio includes modal information, generate a target-language text corresponding to the second audio, where the target-language text includes a punctuation mark and a modal particle corresponding to the modal information.

Example 15. The apparatus according to any one of Examples 12 to 14, where the apparatus further includes:
a third target text generation module configured to, in response to determining that a third audio includes a number, generate a target-language text corresponding to the third audio, where the target-language text includes number content presented in a standardized format.

Example 16. The apparatus according to any one of Examples 12 to 15, where the apparatus further includes:
a fourth target text generation module configured to, in response to determining that a fourth audio includes a polysemous word, generate a target-language text corresponding to the fourth audio, where the target-language text includes a target word of the polysemous word that is related to the context of the audio.

Example 17. The apparatus according to any one of Examples 12 to 16, where the apparatus further includes:
a fifth target text generation module configured to, in response to determining that a fifth audio includes a proper noun, generate a target-language text corresponding to the fifth audio, where the target-language text retains the proper noun.

Example 18. The apparatus according to any one of Examples 12 to 17, where the apparatus further includes:
a sixth target text generation module configured to, in response to determining that a sixth audio includes multilingual content, generate a target-language text corresponding to the sixth audio, where the target-language text retains content in a target language in the multilingual content.

Example 19. The apparatus according to any one of Examples 12 to 18, where the apparatus further includes:
a seventh target text generation module configured to, in response to determining that a seventh audio includes a repeated adverb, generate a target-language text corresponding to the seventh audio, where the adverb in the target-language text is de-duplicated.

Example 20. The apparatus according to any one of Examples 12 to 19, where the target-language text is generated by a speech translation model, and the speech translation model is pre-trained with a chapter-level multilingual document and adjusted using a plurality of tasks.

Example 21. The apparatus according to any one of Examples 12 to 20, where adjusting the speech translation model using the plurality of tasks includes:
a first training data obtaining module configured to obtain a source-language audio and a corresponding punctuated source-language text;
a first training data obtaining module configured to obtain corresponding prompt content based on a punctuated speech transcription task; and
a first translation model adjustment module configured to adjust the speech translation model based on the corresponding prompt content, the source-language audio, and the corresponding punctuated source-language text.

Example 22. The apparatus according to any one of Examples 12 to 21, where adjusting the speech translation model using the plurality of tasks includes:
a second training data obtaining module configured to obtain a source-language audio and a corresponding target-language text with a modal particle;
a second training data obtaining module configured to obtain corresponding prompt content based on a speech translation task; and
a second translation model adjustment module configured to adjust the speech translation model based on the corresponding prompt content, the source-language audio, and the corresponding target-language text with the modal particle.

Example 23. An electronic device, including:
a processor; and
a memory coupled to the processor, the memory having instructions stored thereon, and the instructions, when executed by the processor, causing the electronic device to perform actions, the actions including:
obtaining an audio in a source language, the audio including a specific type of information;
obtaining prompt content related to a target language; and
generating, based on the audio and the prompt content, a target-language text corresponding to the audio, where the target-language text includes a punctuation mark corresponding to the specific type of the information.

Example 24. The device according to Example 23, where the specific type of the information is a predetermined type of word of, and generating the target-language text corresponding to the audio includes:
generating the target-language text including the word presented in a predetermined punctuation mark.

Example 25. The device according to Example 23 or 24, further including:
in response to determining that a second audio includes modal information, generating a target-language text corresponding to the second audio, where the target-language text includes a punctuation mark and a modal particle corresponding to the modal information.

Example 26. The device according to any one of Examples 23 to 25, where the actions further include:
in response to determining that a third audio includes a number, generating a target-language text corresponding to the third audio, where the target-language text includes number content presented in a standardized format.

Example 27. The device according to any one of Examples 23 to 26, where the actions further include:
in response to determining that a fourth audio includes a polysemous word, generating a target-language text corresponding to the fourth audio, where the target-language text includes a target word of the polysemous word that is related to the context of the audio.

Example 28. The device according to any one of Examples 23 to 27, where the actions further include:
in response to determining that a fifth audio includes a proper noun, generating a target-language text corresponding to the fifth audio, where the target-language text retains the proper noun.

Example 29. The device according to any one of Examples 23 to 28, where the actions further include:
in response to determining that a sixth audio includes multilingual content, generating a target-language text corresponding to the sixth audio, where the target-language text retains content in a target language in the multilingual content.

Example 30. The device according to any one of Examples 23 to 29, where the actions further include:
in response to determining that a seventh audio includes a repeated adverb, generating a target-language text corresponding to the seventh audio, where the adverb in the target-language text is de-duplicated.

Example 31. The device according to any one of Examples 23 to 30, where the target-language text is generated by a speech translation model, and the speech translation model is pre-trained with a chapter-level multilingual document and adjusted using a plurality of tasks.

Example 32. The device according to any one of Examples 23 to 31, where adjusting the speech translation model using the plurality of tasks includes:
obtaining a source-language audio and a corresponding punctuated source-language text;
obtaining corresponding prompt content based on a punctuated speech transcription task; and
adjusting the speech translation model based on the corresponding prompt content, the source-language audio, and the corresponding punctuated source-language text.

Example 33. The device according to any one of Examples 23 to 32, where adjusting the speech translation model using the plurality of tasks includes:
obtaining a source-language audio and a corresponding target-language text with a modal particle;
obtaining corresponding prompt content based on a speech translation task; and
adjusting the speech translation model based on the corresponding prompt content, the source-language audio, and the corresponding target-language text with the modal particle.

Example 34. A method for speech translation, including:
obtaining an audio in a source language, the audio including modal information;
obtaining prompt content related to a target language; and
generating, based on the audio and the prompt content, a target-language text corresponding to the audio, where the target-language text includes a punctuation mark and a modal particle corresponding to the modal information.

The method described in Example 34 may be combined with the method described in any one of Examples 1 to 11.

Example 35. A method for speech translation, including:
obtaining an audio in a source language, the audio including multilingual information;
obtaining prompt content related to a target language; and
generating, based on the audio and the prompt content, a target-language text corresponding to the audio, where the target-language text retains content in a target language in the multilingual information.

The method described in Example 35 may be combined with the method described in any one of Examples 1 to 11.

Example 36. A computer-readable storage medium having one or more computer instructions stored thereon, where the one or more computer instructions, when executed by a processor, cause a method according to any one of Examples 1 to 11 and Examples 34 to 35 to be implemented.

Example 37. A computer program product being tangibly stored on a computer-readable medium and including computer-executable instructions, where the computer-executable instructions, when executed by a device, cause the device to perform the method according to any one of Examples 1 to 10 and Examples 34 to 35.

Although the present disclosure has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for speech translation, comprising:
obtaining an audio in a source language, the audio comprising a specific type of information;
obtaining prompt content related to a target language; and
generating, based on the audio and the prompt content, a target-language text corresponding to the audio, wherein the target-language text comprises a punctuation mark corresponding to the specific type of the information.

2. The method according to claim 1, wherein the specific type of the information is a predetermined type of word, and generating the target-language text corresponding to the audio comprises:
generating the target-language text comprising a word presented in a predetermined punctuation mark.

3. The method according to claim 1, further comprising:
in response to determining that a second audio comprises modal information, generating a target-language text corresponding to the second audio, wherein the target-language text comprises a punctuation mark and a modal particle corresponding to the modal information.

4. The method according to claim 1, further comprising:
in response to determining that a third audio comprises a number, generating a target-language text corresponding to the third audio, wherein the target-language text comprises number content presented in a standardized format.

5. The method according to claim 1, further comprising:
in response to determining that a fourth audio comprises a polysemous word, generating a target-language text corresponding to the fourth audio, wherein the target-language text comprises a target word of the polysemous word that is related to a context of the audio.

6. The method according to claim 1, further comprising:
in response to determining that a fifth audio comprises a proper noun, generating a target-language text corresponding to the fifth audio, wherein the proper noun is retained in the target-language text.

7. The method according to claim 1, further comprising:
in response to determining that a sixth audio comprises multilingual content, generating a target-language text corresponding to the sixth audio, wherein content in a target language in the multilingual content is retained in the target-language text.

8. The method according to claim 1, further comprising:
in response to determining that a seventh audio comprises a repeated adverb, generating a target-language text corresponding to the seventh audio, wherein an adverb in the target-language text is de-duplicated.

9. The method according to claim 1, wherein the target-language text is generated by a speech translation model, and the speech translation model is pre-trained with a chapter-level multilingual document and adjusted using a plurality of tasks.

10. The method according to claim 9, wherein adjusting the speech translation model using the plurality of tasks comprises:
obtaining a source-language audio and a corresponding punctuated source-language text;
obtaining corresponding prompt content based on a punctuated speech transcription task; and
adjusting the speech translation model based on the corresponding prompt content, the source-language audio, and the corresponding punctuated source-language text.

11. The method according to claim 9, wherein adjusting the speech translation model using the plurality of tasks comprises:
obtaining a source-language audio and a corresponding target-language text with a modal particle;
obtaining corresponding prompt content based on a speech translation task; and
adjusting the speech translation model based on the corresponding prompt content, the source-language audio, and the corresponding target-language text with the modal particle.

12. An electronic device, comprising:
a processor; and
a memory coupled to the processor, the memory having instructions stored thereon, wherein the instructions, when executed by the processor, causes the electronic device to:
obtain an audio in a source language, the audio comprising a specific type of information;
obtain prompt content related to a target language; and
generate, based on the audio and the prompt content, a target-language text corresponding to the audio, wherein the target-language text comprises a punctuation mark corresponding to the specific type of the information.

13. The electronic device according to claim 12, wherein the specific type of the information is a predetermined type of word, and the electronic device is caused to generate the target-language text corresponding to the audio by being caused to:
generate the target-language text comprising a word presented in a predetermined punctuation mark.

14. The electronic device according to claim 13, wherein the electronic device is further caused to:
in response to determining that a second audio comprises modal information, generate a target-language text corresponding to the second audio, wherein the target-language text comprises a punctuation mark and a modal particle corresponding to the modal information.

15. The electronic device according to claim 12, wherein the electronic device is further caused to:
in response to determining that a third audio comprises a number, generate a target-language text corresponding to the third audio, wherein the target-language text comprises number content presented in a standardized format.

16. The electronic device according to claim 12, wherein the electronic device is further caused to:
in response to determining that a fourth audio comprises a polysemous word, generate a target-language text corresponding to the fourth audio, wherein the target-language text comprises a target word of the polysemous word that is related to a context of the audio.

17. The electronic device according to claim 12, wherein the electronic device is further caused to:
in response to determining that a fifth audio comprises a proper noun, generate a target-language text corresponding to the fifth audio, wherein the proper noun is retained in the target-language text.

18. The electronic device according to claim 12, wherein the electronic device is further caused to:
in response to determining that a sixth audio comprises multilingual content, generate a target-language text corresponding to the sixth audio, wherein content in a target language in the multilingual content is retained in the target-language text.

19. The electronic device according to claim 12, wherein the electronic device is further caused to:
in response to determining that a seventh audio comprises a repeated adverb, generate a target-language text corresponding to the seventh audio, wherein an adverb in the target-language text is de-duplicated.

20. A non-transitory computer-readable storage medium having computer-executable instructions stored thereon, wherein the computer-executable instructions, when executed by a processor, implement:
obtaining an audio in a source language, the audio comprising a specific type of information;
obtaining prompt content related to a target language; and
generating, based on the audio and the prompt content, a target-language text corresponding to the audio, wherein the target-language text comprises a punctuation mark corresponding to the specific type of the information.
